(19) United States
(12) Patent Application Publication
(10) Pub. No.: US 2009/0116142 A1
(43) Pub. Date: May 7, 2009

(54) Disk device

(75) Inventor: Takashi Hikosaka, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/289,109

(22) Filed: Oct. 21, 2008

(30) Foreign Application Priority Data
Nov. 7, 2007 (JP) 2007-290065

(51) Int. Cl. G11B 33/14

(52) U.S. Cl. 360/97.02; G9B/33.035

(57) ABSTRACT

In a disk device, an arm for supporting a head includes upper and lower plates that are located parallel to a surface of a magnetic disk. The lower plate has a linear expansion coefficient greater than that of the upper plate. The upper and lower plates are provided with an electrically-heated wire. When a present altitude of the disk device exceeds a threshold altitude, an electric current is supplied to the heated wire so that the upper and lower plates are expanded. Due to a difference in the linear expansion coefficients between the upper and lower plates, the arm is warped in a direction away from the magnetic disk so that a distance between the head and the surface of the magnetic disk is increased.

### CROSS REFERENCE TO RELATED APPLICATION

This application is based on and incorporates herein by reference Japanese Patent Application No. 2007-290065 filed on Nov. 7, 2007.

### FIELD OF THE INVENTION

The present invention relates to disk devices and, in particular, relates to a disk device capable of being used even at a high altitude.

### BACKGROUND OF THE INVENTION

A hard disk device generally includes a magnetic disk (i.e., platter), a read/write head facing a surface of the magnetic disk to read and write data from and to the magnetic disk, and an arm for supporting the head.

The magnetic disk rotates at a very high speed during use of the hard disk device. When the magnetic disk is rotating, the head floats on a thin layer of air slightly above the surface of the magnetic disk. The head reads and writes data from and to the magnetic disk while flowing above the magnetic disk. However, the thickness of the layer of air between the head and the magnetic disk is reduced at a high attitude due to a drop in atmospheric pressure. As a result, the head may hit the magnetic disk.

In a technique disclosed in JP-A-2005-222695, a rotational speed of a magnetic disk is increased above a rated rotational speed in response to a drop in atmospheric pressure. In such an approach, a distance between a read/write head and the magnetic disk is increased so that the head can be prevented from hitting the magnetic disk. In a technique disclosed in JP-A-2006-92709, a heater is mounted to a slider that has a read/write head and faces a magnetic disk. The heater is mounted to face the magnetic disk. A distance between the head and the magnetic disk is increased by heating air between the slider and the magnetic disk using the heater. Thus, the head can be prevented from hitting the magnetic disk.

As described above, in the technique disclosed in JP-A-2005-222695, the magnetic disk is caused to rotate at a speed above the rated rotational speed. Therefore, the rated rotational speed needs to be set lower than usual. As a result, a hard disk device employing the technique has a reduced a storage capacity. In the technique disclosed in JP-A-2006-92709, air between the slider and the magnetic disk is heated by the heater to increase the distance between the head and the magnetic disk. In this case, the distance is likely to change with a change in a temperature. Therefore, it is difficult to accurately control the distance. If the distance becomes too small, the head may hit the magnetic disk. Conversely, if the distance becomes too large, the head may fail to read and write data from and to the magnetic disk.

### SUMMARY OF THE INVENTION

In view of the above-described problem, it is an object of the present invention to provide a disk device in which a head distance between a head and a magnetic disk is accurately controlled even at a high altitude.

According to a first aspect of the present invention, a disk device includes a rotatable magnetic disk, a head, an arm, an electrically-heated member, a distance determination circuit, and a distance control circuit. The head is located to face a surface of the magnetic disk and reads and/or writes data from and/or to the magnetic disk. The arm supports the head at one end and includes upper and lower plate members that are located parallel to the surface of the magnetic disk. The lower plate member is located between the upper plate member and the surface of the magnetic disk. The electrically-heated member heats the upper and lower plate members of the arm by receiving an electric current. The distance determination circuit determines a head distance associated value that is associated with a head distance between the head and the surface of the magnetic disk. The distance control circuit increases the head distance by supplying the electric current to the heated member, when the head distance associated value indicates that the head distance is less than a threshold distance. The upper plate member has a first linear expansion coefficient. The lower plate member has a second linear expansion coefficient greater than the first linear expansion coefficient.

According to a second aspect of the present invention, a disk device includes a rotatable magnetic disk, a head, an arm, an electrically-heated member, a distance determination circuit, and a distance control circuit. The head faces a surface of the magnetic disk and reads and/or writes data from and/or to the magnetic disk. The arm supports the head at one end and includes upper and lower plate members that are located parallel to the surface of the magnetic disk. The lower plate member is located between the upper plate member and the surface of the magnetic disk. The electrically-heated member heats the lower plate member of the arm by receiving an electric current. The distance determination circuit determines a head distance associated value that is associated with a head distance between the head and the surface of the magnetic disk. The distance control circuit increases the head distance by supplying the electric current to the heated member, when the head distance associated value indicates that the head distance is less than a threshold distance.

According to a third aspect of the present invention, a disk device includes a rotatable magnetic disk, a head, an arm, an electrically-heated member, a distance determination circuit, and a distance control circuit. The head faces a surface of the magnetic disk and reads and/or writes data from and/or to the magnetic disk. The arm supports the head at one end and includes an elastic member having an elasticity that increases with an increase in a temperature. The electrically-heated member heats the elastic member of the arm by receiving an electric current. The distance determination circuit determines a head distance associated value that is associated with a head distance between the head and the surface of the magnetic disk. The distance control circuit increases the elasticity of the elastic member of the arm by supplying the electric current to the heated member, when the head distance associated value indicates that the head distance is less than a threshold distance.

### BRIEF DESCRIPTION OF THE DRAWINGS

The above and other objectives, features and advantages of the present invention will become more apparent from the following detailed description made with check to the accompanying drawings. In the drawings:

FIG. 1 is a diagram illustrating a perspective view of a hard disk device according to a first embodiment of the present invention;

FIG. 2 is a diagram illustrating a gimbal of the hard disk device of FIG. 1;

FIG. 3 is a block diagram illustrating processes performed by a processing unit of the hard disk device of FIG. 1;

FIG. 4 is a block diagram illustrating processes performed by a processing unit of a hard disk device according to a second embodiment of the present invention;

FIG. 5 is a diagram illustrating a bottom view of a gimbal of a hard disk device according to a third embodiment of the present invention;

FIG. 6 is a diagram illustrating a front view of the gimbal viewed from a direction indicated by an arrow VI of FIG. 5; and

FIG. 7 is a diagram illustrating a side view of a gimbal of a hard disk device according to a fourth embodiment of the present invention.

### DETAILED DESCRIPTION OF THE PREFERRED EMBODIMENTS

### First Embodiment

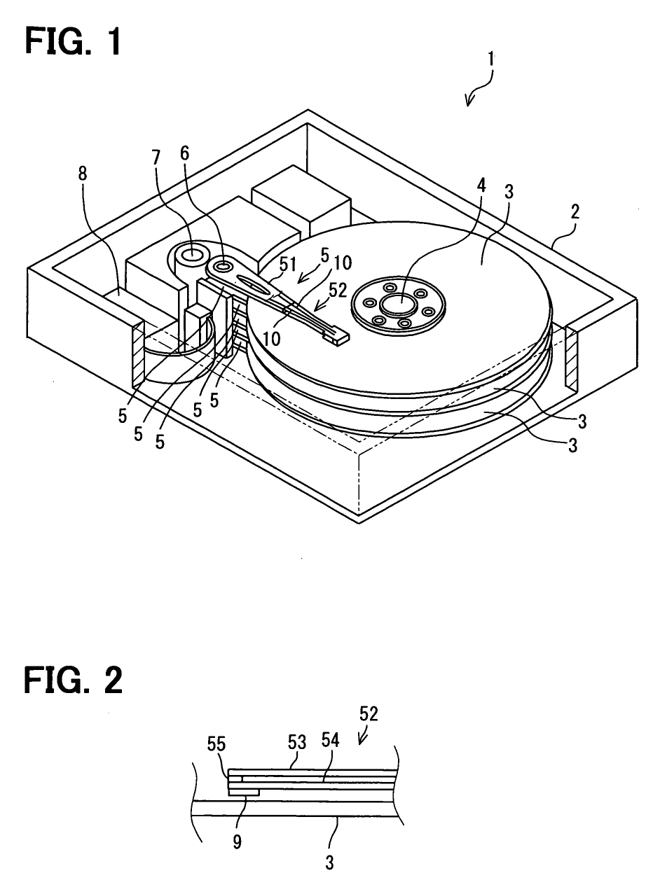

Referring to FIG. 1, a hard disk device 1 according to a first embodiment of the present invention includes a case 2 and a plurality of magnetic disks (i.e., platters with magnetic surfaces) 3 housed in the case 2. In the first embodiment, the hard disk device 1 includes three magnetic disks 3. Each magnetic disk 3 is circular and identical in shape.

The magnetic disks 3 are attached to a common spindle shaft 4 in such a manner that the magnetic disks 3 are held parallel to a bottom of the case 2 and equally spaced from each other. The spindle shaft 4 is responsible for causing the magnetic disks 3 to rotate.

Each magnetic disk 3 is provided with a pair of arms 5. The arms 5 face both sides of the magnetic disk 3, respectively, so that data can be read from and written to both sides of the magnetic disk 3. Each arm 5 can swing on a common axis 6 to a predetermined angle. A voice coil motor 7 allows the arm 5 to swing. A processing unit 8 controls the spindle shaft 4 and the voice coil motor 7 to control the rotation of the magnetic disk 3 and the swing of the arm 5.

Each arm 5 includes a base 51 attached to the axis 6 and a gimbal 52 mounted at the tip of the base 51. As shown in FIG. 2, the gimbal 52 includes upper and lower long plates 53, 54 that are held parallel to a surface of the magnetic disk 3 A spacer 55 is interposed between ends of the upper and lower long plates 53, 54 so that the upper and lower long plates 53, 54 can be spaced from each other. The upper long plate 53 is made of a first metallic material having a first coefficient of linear expansion. The lower long plate 54 is made of a second metallic material having a second coefficient of linear expansion. The second linear expansion coefficient of the lower long plate 54 is greater than the first linear expansion coefficient of the upper long plate 53.

A read/write head 9 is fixed to the end of a bottom surface of the lower long plate 54 to face the surface of the magnetic disk 3. Data is magnetically read from and written to the magnetic disk 3 by the head 9.

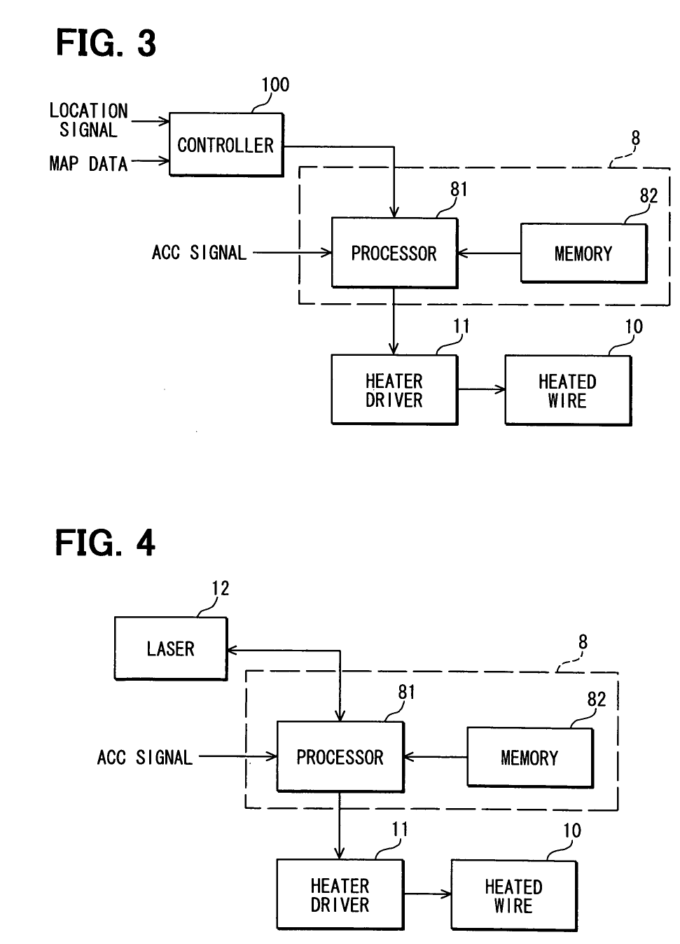

Further, as shown in FIG. 1, two electrically-heated wires 10 are fixed to a top surface of the upper long plate 53. Although not shown in the drawings, additional two electrically-heated wires 10 are fixed to the lower long plate 54. Each heated wire 10 generates heat depending on a magnitude of an electric current supplied from a heater driver 11 shown in FIG. 3.

When the electric current flows through the heated wire 10 fixed to the upper and lower long plates 53, 54, the heat generated by the heated wire 10 is transferred to the upper and lower long plates 53, 54. As a result, temperatures of the upper and lower long plates 53, 54 are increased, and the upper and lower long plates 53, 54 are expanded accordingly. Since the second linear expansion coefficient of the lower long plate 54 is greater than the first linear expansion coefficient of the upper long plate 53, the lower long plate 54 is much more expanded than the upper long plate 53. Thus, the gimbal 52 is warped in a direction away from the magnetic disk 3, and accordingly the head 9 fixed to the end of the gimbal 52 is displaced in the direction away from the magnetic disk 3. The amount of the warpage of the gimbal 52 depends on the amount of the expansion of the upper and lower long plates 53, 54. The amount of the expansion of the upper and lower long plates 53, 54 depends on the magnitude of the electric current supplied to the electrically-heated wires 10. Therefore, a head distance between the head 9 and the magnetic disk 3 can be controlled by controlling the magnitude of the electric current supplied to the heated wire 10.

As mentioned previously, the processing unit 8 controls the spindle shaft 4 and the voice coil motor 7 to control the rotation of the magnetic disk 3 and the swing of the arm 5. In addition, the processing unit 8 causes the head 9 to read and write data from and to the magnetic disk 3. Further, the processing unit 8 performs an altitude determination process for successively determining a present altitude and a head distance control process for controlling the head distance between the head 9 and the magnetic disk 3 based on the preset altitude. Thus, the present altitude is associated with the head distance and used as a head distance associated value.

FIG. 3 shows a block diagram related to the altitude determination process and the head distance control process performed by the processing unit 8. A controller 100 is included in a navigation apparatus mounted on a vehicle and performs a present location determination process, a route guidance process, and the like. For example, the controller 100 receives a location signal from a location detector (not shown) and successively determines a present location, including the present altitude, of the vehicle based on the location signal. Further, the controller 100 receives map data from a map data input device and provides route guidance using the map data.

In the first embodiment, the hard disk device 1 is included in the navigation apparatus. The processor 81 of the processing unit 8 successively receives an altitude signal indicating the present altitude from the controller 100.

The processing unit 8 has a memory 82 that stores an altitude-current table defining a mapping between the present altitude and the magnitude of the electric current supplied to the heated wire 10. It is preferable that the memory 82 be a nonvolatile memory such as an electrically erasable programmable read-only memory (EEPROM).

In the altitude-current table, the electric current is kept zero until the present altitude exceeds a threshold altitude. When the present altitude exceeds the threshold altitude, the electric current stepwise or continuously increases with an increase in the present altitude. The threshold altitude is set to about a maximum usable altitude (e.g., 3000 meters) of the hard disk device 1.

The altitude-current table is created in the following manner. A first relationship between the present altitude and a reduction in the head distance is measured. Further, a second relationship between the magnitude of the electric current supplied to the heated wire 10 and the amount of the warpage of the gimbal 52 is measured. Based on the first and second relationships, the magnitude of the electric current supplied to the heated wire 10 is determined such that the gimbal 52 can be warped to correct (i.e., cancel) the reduction of the head distance due to the increase in the present altitude.

The processor 81 receives an accessory (ACC) signal and detects that an ignition of the vehicle is in an accessory position upon receipt of the accessory signal. Then, if the processor 81 further detects that the hard disk device 1 is in operation now, the processor 81 performs the altitude determination process and the head distance control process described below.

Firstly, the processor 81 obtains the altitude signal indicating the present altitude from the controller 100 of the navigation apparatus. If the present altitude is less than or equal to the threshold altitude, the processor 81 determines that the head distance is a normal distance between the head 9 and the magnetic disk 3. Then, the processor 81 causes the magnitude of the electric current supplied to the heated wires 10 to be zero. Conversely, if the present altitude exceeds the threshold altitude, the processor 81 determines that the head distance is above the normal distance. Then, the processor 81 decides the magnitude of the electric current supplied to the heated wire 10 by referring to the altitude-current table stored in the memory 82. Then, the processor 81 transmits to the heater driver 11 a command signal to cause the heater driver 11 to supply the electric current having the magnitude to the heated wire 10. The heater driver 11 decides a duty ratio corresponding to the magnitude based on the command signal and supplies the electric current having the duty ratio to the heated wire 10.

In such an approach, the gimbal 52 is warped to correct the reduction in the head distance due to a drop in atmospheric pressure so that the head distance between the head 9 and the magnetic disk 3 can be kept to the normal distance even at a high altitude. Therefore, the head 9 can be prevented from hitting the magnetic disk 3 and also can properly read and write data from and to the magnetic disk 3.

According to the first embodiment, the head distance is controlled without controlling a rotational speed of the magnetic disk 3. In such an approach, there is no need to reduce a rated rotational speed of the magnetic disk 3. Further, the head distance is controlled without heating air. In such an approach, the effect of a temperature change on accuracy of control of the head distance is reduced so that the head distance can be controlled accurately.

### Second Embodiment

A second embodiment of the present invention is described below with reference to FIG. 4. FIG. 4 shows a block diagram related to a head distance determination process and a head distance control process performed by a processing unit 8 of the second embodiment. A difference between the first and second embodiment is as follows.

In the first embodiment, the present altitude detected by the navigation apparatus is associated with the head distance between the magnetic disk 3 and the head 9. That is, the head distance is measured (estimated) based on the present altitude. In the second embodiment, on the other hand, the head distance is actually measured by a laser device 12.

The laser device 12 includes a laser emitter (not shown) and a laser receiver (not shown). The laser emitter and the laser receiver are fixed to the head 9 or the lower surface of the lower long plate 54 so that the laser emitter and the laser receiver can face the magnetic disk 3. The laser emitter emits laser light to the magnetic disk 3, and the laser receiver receives the laser light reflected from the magnetic disk 3.

The processor 81 controls the laser device 12 to cause the laser emitter to emit the laser light. The processor 81 measures time from when the laser emitter emits the laser light to when the laser receiver receives the reflected laser light. The processor 81 measures the head distance between the head 9 and the magnetic disk 3 based on the measured time.

The memory 82 of the second embodiment stores a distance-current table defining a mapping between the head distance and the magnitude of the electric current supplied to the heated wire 10. In the distance-current table, the electric current is kept zero until the measured head distance becomes less than or equal to a threshold distance. When the measured head distance becomes less than or equal to the threshold distance, the electric current stepwise or continuously increases with a decrease in the measured head distance. The threshold distance is set to a normal distance between the head 9 and the magnetic disk 3.

The distance-current table is created in the following manner. A relationship between the magnitude of the electric current supplied to the heated wire 10 and the amount of the warpage of the gimbal 52 is measured. Based on the relationship, the magnitude of the electric current supplied to the heated wire 10 is decided such that the warpage of the gimbal 52 can be equal to a difference between the measured head distance and the threshold distance.

Like the first embodiment, the processor 81 receives the accessory signal and detects that the ignition of the vehicle is in the accessory position upon receipt of the accessory signal. Then, if the processor 81 further detects that the hard disk device 1 is in operation now, the processor 81 performs the head distance determination process and the head distance control process described below.

Firstly, the processor 81 causes the laser emitter of the laser device 12 to emit the laser light to the magnetic disk 3. Then, the processor 81 measures the time from when the laser emitter emits the laser light to when the laser receiver of the laser device 12 receives the laser light reflected from the magnetic disk 3. Then, the processor 81 measures the head distance between the head 9 and the magnetic disk 3 based on the measured time. If the measured head distance exceeds the threshold distance, the processor 81 causes the magnitude of the electric current supplied to the heated wire 10 to be zero. Conversely, if the measured head distance is less than or equal to the threshold distance, the processor 81 decides the magnitude of the electric current supplied to the heated wire 10 by referring to the distance-current table stored in the memory 82.

Then, the processor 81 transmits to the heater driver 11 the command signal to cause the heater driver 11 to supply the electric current having the magnitude to the heated wire 10. The heater driver 11 decides the duty ratio corresponding to the magnitude based on the command signal and supplies the electric current having the duty ratio to the heated wire 10. In such an approach, the gimbal 52 is warped to eliminate the difference between the measured head distance and the threshold distance due to the drop in atmospheric pressure. Therefore, the head distance can be kept to the threshold distance (i.e., normal distance) so that the head 9 can be prevented from hitting the magnetic disk 3 even at a high altitude.

According to the second embodiment, the head distance is controlled without controlling the rotational speed of the magnetic disk 3. In such an approach, there is no need to reduce the rated rotational speed of the magnetic disk 3. Further, the head distance is controlled without heating air. In such an approach, the effect of the temperature change on accuracy of control of the head distance is reduced so that the head distance can be accurately controlled.

### Third Embodiment

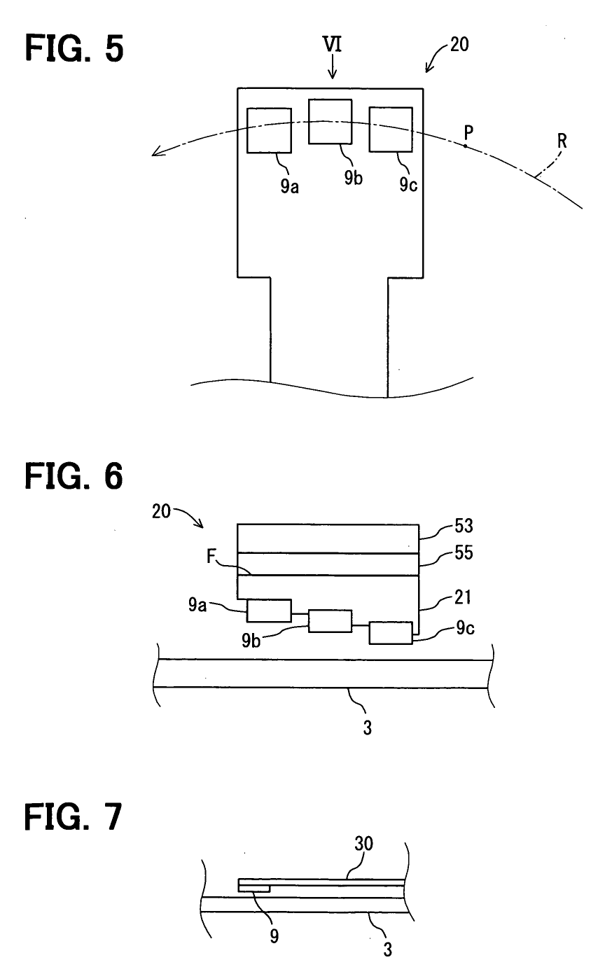

A third embodiment of the present invention is described below with reference to FIGS. 5, 6. FIG. 5 shows a gimbal 20 of the third embodiment viewed from the magnetic disk 3 side. FIG. 6 show the gimbal 20 viewed from a direction indicated by an arrow VI of FIG. 5. A difference between the second and third embodiment is as follows.

As shown in FIGS. 5, 6, three read-write heads 9a-9c are fixed to the end of the gimbal 20. Each of the heads 9a-9c has the same function as the head 9 of the second embodiment. The gimbal 20 includes the upper long plate 53 and a lower long plate 21 that are held parallel to the magnetic disk 3 The spacer 55 is interposed between ends of the upper and lower long plates 53, 21 so that the upper and lower long plates 53, 21 can be spaced from each other.

As can been from FIG. 5, the heads 9a-9c are arranged along a rotational direction R of the magnetic disk 3 so that a point P on the magnetic disk 3 can pass under each of the heads 9a-9c.

Therefore, the heads 9a-9c can be configured to read the same data from the magnetic disk 3. However, as shown in FIG. 6, the lower long plate 21 has three portions having different thicknesses. The heads 9a-9c are fixed to the three portions, respectively. As a result, distances from a top surface F of the lower long plate 21 to the heads 9a-9c are different from each other. Specifically, a first distance between the top surface F and the head 9a is greater than a second distance between the top surface F and the head 9b. The second distance is greater than a third distance between the top surface F and the head 9c. A first difference between the first and second distances is equal to a second difference between the second and third distances. The first difference is adjusted such that when the head 9b can read data from the magnetic disk 3 in a normal condition, the head 9a cannot read data from the magnetic disk 3. In this way, the heads 9a-9c are located at different heights from the surface of the magnetic disk 3.

In the third embodiment, if each of the heads 9b, 9c can (i.e., is allowed to) read data despite the fact that the head 9a cannot read data, the processor 81 determines that the head distance is equal to the threshold distance. If only the head 9c can read data, the processor 81 determines that the head distance is greater than the threshold distance by a predetermined distance α. If none of the heads 9a-9c can read data, the processor 81 determines that the head distance is greater than the threshold distance by a predetermined distance 2α. If all of the heads 9a-9c can read data, the processor 81 determines that the head distance is less than the threshold distance by the distance α. In this way, the processor 81 measures (estimates) the head distance without using the laser device 12 of the second embodiment. Then, like the second embodiment, the processor 81 decides the magnitude of the electric current supplied to the heated wire 10 by referring to the distance-current table stored in the memory 82.

### Fourth Embodiment

A fourth embodiment of the present invention is described below with reference to FIG. 7. FIG. 7 shows a side view of a gimbal 30 of the fourth embodiment. The gimbal 30 is made of an elastic material having a rubber elasticity. The elasticity of the gimbal 30 increases with an increase in a temperature. The gimbal 30 has the same shape as the lower long plate 54 of the gimbal 52. The head 9 is fixed to the end of a bottom surface of the gimbal 30 to face the surface of the magnetic disk 3. Although not shown in FIG. 7, like the first embodiment, the gimbal 30 is mounted at the tip of the base 51 of the arm 5, and the heated wire 10 is fixed to the gimbal 30.

In the fourth embodiment, the processor 81 performs the head distance determination process of the preceding embodiments to successively measure the head distance between the head 9 and the magnetic disk 3. Further, the processor 81 performs an elasticity control process instead of the head distance control process of the preceding embodiments. The elasticity control process is described later. The memory 82 stores a distance-current table defining a mapping between the head distance and the magnitude of the electric current supplied to the heated wire 10.

In the distance-current table, the electric current is kept zero until the measured head distance becomes less than or equal to a threshold distance. When the measured head distance becomes less than or equal to the threshold distance, the electric current stepwise or continuously increases with a decrease in the measured head distance. The threshold distance is set to a normal distance between the head 9 and the magnetic disk 3.

The distance-current table is created in the following manner. An external force applied to the end of the gimbal 30 by an airflow caused by the magnetic disk 3 rotating at a rated rotational speed is measured. Since the gimbal 30 is made of the elastic material, the gimbal 30 is elastically deformed by the external force. The amount of the elastic deformation of the gimbal 30 depends on not only the external force but also the elasticity of the gimbal 30. As mentioned previously, the elasticity of the gimbal 30 increases with the increase in the temperature. Therefore, the elasticity of the gimbal 30 depends on the magnitude of the electric current supplied to the gimbal 30. In the distance-current table, the magnitude of the electric current supplied to the heated wire 10 is determined such that the gimbal 30 can be elastically deformed to eliminate the difference between the measured head distance and the threshold distance.

The elasticity control process performed by the processor 81 is described below. In the elasticity control process, the processor 81 determines whether the measured head distance is greater than or equal to the threshold distance. If the measured head distance is greater than or equal to the threshold distance, the processor 81 causes the magnitude of the electric current supplied to the heated wire 10 to be zero. Conversely, if the measured head distance is less than the threshold distance, the processor 81 decides the magnitude of the electric current supplied to the heated wire 10 by referring to the altitude-current table stored in the memory 82. Then, the processor 81 transmits to the heater driver 11 the command signal to cause the heater driver 11 to supply the electric current having the magnitude to the heated wire 10. The heater driver 11 decides the duty ratio corresponding to the magnitude based on the command signal and supplies the electric current having the duty ratio to the heated wire 10. In such an approach, the gimbal 30 is elastically deformed to eliminate the difference between the measured head distance and the threshold distance due to the drop in atmospheric pressure. Therefore, the head distance can be kept to the threshold distance (i.e., normal distance) so that the head 9 can be prevented from hitting the magnetic disk 3 even at a high altitude.

According to the fourth embodiment, the head distance is controlled without controlling the rotational speed of the magnetic disk 3. In such an approach, there is no need to reduce the rated rotational speed of the magnetic disk 3. Further, the head distance is controlled without heating air. In such an approach, the effect of the temperature change on accuracy of control of the head distance is reduced so that the head distance can be accurately controlled.

### Modifications

The embodiments described above may be modified in various ways. For example, in the first embodiment, the upper and lower long plates 53, 54 of the gimbal 52 can be made of a metallic material having the same coefficient of linear expansion. In this case, the heated wire 10 is fixed to only the lower long plate 54. In such an approach, only the lower long plate 54 is expanded by the electric current supplied to the heated wire 10 so that the gimbal 52 can be warped in the direction away from the magnetic disk 3. An electrically-heated film can be used instead of the heated wire 10.

In the embodiments, the head 9 is directly fixed to the gimbals 20, 30, or 52. Alternatively, the head 9 can be fixed to a slider that is fixed to the gimbals 20, 30, or 52. In the embodiments, the head 9 performs both of reading and writing data. Alternatively, the head 9 can perform at least one of reading and writing data. In the fourth embodiment, the present altitude can be used instead of the head distance.

Such changes and modifications are to be understood as being within the scope of the present invention as defined by the appended claims.

What is claimed is:

1. A disk device comprising:
a rotatable magnetic disk;
a head located to face a surface of the magnetic disk and configured to read data from and/or write data to the magnetic disk;
an arm configured to support the head at one end, the arm including upper and lower plate members that are located parallel to the surface of the magnetic disk, the lower plate member being located between the upper plate member and the surface of the magnetic disk;
an electrically-heated member configured to heat the upper and lower plate members of the arm by receiving an electric current;
a distance determination circuit configured to determine a head distance associated value that is associated with a head distance between the head and the surface of the magnetic disk; and
a distance control circuit configured to increase the head distance by supplying the electric current to the heated member when the head distance associated value indicates that the head distance is less than a threshold distance,
wherein the upper plate member has a first linear expansion coefficient, and
wherein the lower plate member has a second linear expansion coefficient greater than the first linear expansion coefficient.

2. The disk device according to claim 1,
wherein each of the upper and lower plate members of the arm is made of a metallic material.

3. The disk device according to claim 1,
wherein the distance determination circuit obtains a present altitude of the disk device from a navigation apparatus and uses the obtained altitude as the head distance associated value.

4. The disk device according to claim 1, further comprising:
a laser device configured to emit laser light to the surface of the magnetic disk and configured to detect the laser light reflected from the surface of the magnetic disk,
wherein the distance determination circuit obtains a time elapsed from when the laser light is emitted to when the reflected laser light is detected, and
wherein the distance determination circuit uses the obtained time as the head distance associated value.

5. The disk device according to claim 1,
wherein the head comprises a plurality of heads that are arranged along a rotational direction of the magnetic disk and supported by the arm at different heights from the surface of the magnetic disk,
wherein the distance determination circuit obtains the number of the plurality of heads that are allowed to read the data from the magnetic disk, and
wherein the distance determination circuit uses the obtained number as the head distance associated value.

6. A disk device comprising:
a rotatable magnetic disk;
a head located to face a surface of the magnetic disk and configured to read data from and/or write data to the magnetic disk;
an arm configured to support the head at one end, the arm including upper and lower plate members that are located parallel to the surface of the magnetic disk, the lower plate member being located between the upper plate member and the surface of the magnetic disk;
an electrically-heated member configured to heat the lower plate member of the arm by receiving an electric current;
a distance determination circuit configured to determine a head distance associated value that is associated with a head distance between the head and the surface of the magnetic disk; and
a distance control circuit configured to increase the head distance by supplying the electric current to the heated member when the head distance associated value indicates that the head distance is less than a threshold distance.

7. The disk device according to claim 6,
wherein the distance determination circuit obtains a present altitude of the disk device from a navigation apparatus and uses the obtained altitude as the head distance associated value.

8. The disk device according to claim 6, further comprising:
a laser device configured to emit laser light to the surface of the magnetic disk and configured to detect the laser light reflected from the surface of the magnetic disk,
wherein the distance determination circuit obtains a time elapsed from when the laser light is emitted to when the reflected laser light is detected, and
wherein the distance determination circuit uses the obtained time as the head distance associated value.

9. The disk device according to claim 6,
wherein the head comprises a plurality of heads that are arranged along a rotational direction of the magnetic disk and supported by the arm at different heights from the surface of the magnetic disk,
wherein the distance determination circuit obtains the number of the plurality of heads that are allowed to read the data from the magnetic disk, and
wherein the distance determination circuit uses the obtained number as the head distance associated value.

10. A disk device comprising:
a rotatable magnetic disk;
a head located to face a surface of the magnetic disk and configured to read data from and/or write data to the magnetic disk;
an arm configured to support the head at one end, the arm including an elastic member having an elasticity that increases with an increase in a temperature;
an electrically-heated member configured to heat the elastic member of the arm by receiving an electric current;
a distance determination circuit configured to determine a head distance associated value that is associated with a head distance between the head and the surface of the magnetic disk; and
a distance control circuit configured to increase the elasticity of the elastic member of the arm by supplying the electric current to the heated member when the head distance associated value indicates that the head distance is less than a threshold distance.

11. The disk device according to claim 10,
wherein the distance determination circuit obtains present altitude of the disk device from a navigation apparatus and uses the obtained altitude as the head distance associated value.

12. The disk device according to claim 10, further comprising:
a laser device configured to emit laser light to the surface of the magnetic disk and configured to detect the laser light reflected from the surface of the magnetic disk,
wherein the distance determination circuit obtains a time elapsed from when the laser light is emitted to when the reflected laser light is detected, and
wherein the distance determination circuit uses the obtained time as the head distance associated value.

13. The disk device according to claim 10,
wherein the head comprises a plurality of heads that are arranged along a rotational direction of the magnetic disk and supported by the arm at different heights from the surface of the magnetic disk,
wherein the distance determination circuit obtains the number of the plurality of heads that are allowed to read the data from the magnetic disk, and
wherein the distance determination circuit uses the obtained number as the head distance associated value.
